(19) United States
(12) Patent Application Publication
(10) Pub. No.: US 2001/0011931 A1
(43) Pub. Date: Aug. 9, 2001

(54) Directional coupler having a coupling factor which can easily be adjusted

(75) Inventors: Takao Suzuki, Tokyo (JP); Yoshihiro Sugii, Iruma-shi (JP); Takayoshi Oyake, Asaka-shi (JP); Hiroyuki Mizushina, Tokyo (JP)

Correspondence Address: LAFF, WHITESEL & SARET, LTD, 401 North Michigan Avenue, Chicago, IL, 60611, US

(73) Assignee: Japan Aviation Electronics Industry, Limited

(21) Appl. No.: 09/777,803

(22) Filed: Feb. 6, 2001

(30) Foreign Application Priority Data
Feb. 7, 2000 (JP) 29199/2000

(51) Int. Cl. H01P 5/18

(52) U.S. Cl. 333/111; 333/115

(57) ABSTRACT

A directional coupler is provided with a primary line extending along a first axis and supported by a support member and with a subsidiary line extending along a second axis and supported by the support member to be rotatable with respect to the second axis. The subsidiary line has a conductive particular portion arranged substantially in parallel to the primary line with a distance kept therefrom. The particular portion has a peripheral surface adapted to vary the distance in response to the rotation of the subsidiary line.

### BACKGROUND OF THE INVENTION

This invention relates to a directional coupler.

A conventional directional coupler is disclosed, for example, in Japanese Unexamined Patent Publication (JP-A) No. H09-261612. In this directional coupler, a coupling factor has a fixed value. It is difficult to adjust the coupling factor.

Another conventional directional coupler is disclosed in Japanese Unexamined Utility Model Publication (JP-U) No. H03-59. In this directional coupler, it is possible to adjust the coupling factor. However, the adjustment of the coupling factor is restricted in a narrow range. Therefore, this directional coupler is not applicable to a special case where a strict tolerance in coupling factor is required. Particularly for loose coupling on the order of 40 dB, fine adjustment is impossible. In this event, it is necessary to prepare a number of kinds of directional couplers and to use an appropriate one selected therefrom. This results in an increase in cost.

In case of such loose coupling, the coupling factor is greatly affected by parts tolerance of the directional coupler. The parts tolerance depends upon an experience of a worker. This is also one of cost-increasing factors.

### SUMMARY OF THE INVENTION

It is therefore an object of this invention to provide a directional coupler having a coupling factor which can easily and repeatedly be adjusted.

It is another object of this invention to provide a directional coupler having a coupling factor which can be adjusted over a wide range.

It is still another object of this invention to provide a directional coupler having a coupling factor which can be finely adjusted even in case of loose coupling.

Other objects of the present invention will become clear as the description proceeds.

According to this invention, there is provided a directional coupler including a support member, a primary line extending along a first axis and supported by the support member, and a subsidiary line extending along a second axis and supported by the support member to be rotatable with respect to the second axis. The subsidiary line has a conductive particular portion arranged substantially in parallel to the primary line with a distance kept therefrom. The particular portion has a peripheral surface adapted to vary the distance in response to the rotation of the subsidiary line.

### BRIEF DESCRIPTION OF THE DRAWING

FIG. 1 is a plan view of a directional coupler according to a first embodiment of this invention;

FIG. 2 is a front view of the directional coupler illustrated in FIG. 1;

FIG. 3 is a right side view of the directional coupler illustrated in FIG. 1;

FIG. 4 is a left side view of the directional coupler illustrated in FIG. 1;

FIG. 5 is a sectional view taken along a line V-V in FIG. 2;

FIG. 6 is a sectional view taken along a line VI-VI in FIG. 5;

FIG. 7 is a sectional view taken along a line VII-VII in FIG. 5;

FIG. 8 is a sectional view taken along a line VIII-VIII in FIG. 5;

FIG. 9 is a vertically-cut perspective view of the directional coupler illustrated in FIGS. 1 to 8;

FIG. 10 is an exploded perspective view of a subsidiary line in the directional coupler illustrated in FIGS. 1 to 8;

FIG. 11 is a sectional view taken along a line XI-XI in FIG. 10;

FIGS. 12A to 12D are views for describing an operation of the directional coupler illustrated in FIGS. 1 to 8;

FIG. 13 is a sectional view similar to FIG. 5 but in a modification of the directional coupler illustrated in FIGS. 1 to 8;

FIG. 14 is a sectional view similar to FIG. 5 but in a directional coupler according to a second embodiment of this invention;

FIG. 15 is a vertically-cut perspective view similar to FIG. 9 but in the directional coupler illustrated in FIG. 14;

FIGS. 16A and 16B are views for describing an operation of the directional coupler illustrated in FIG. 14;

FIG. 17 is a sectional view similar to FIG. 14 but in a modification of the directional coupler illustrated in FIG. 14;

FIG. 18 is a schematic view for describing a first example of a structure of fixing a subsidiary line to a support member;

FIG. 19 is a schematic view for describing a second example of the structure of fixing the subsidiary line to the support member;

FIG. 20 shows test data for the relationship between a coupling factor and a rotation angle of the subsidiary line in the directional coupler of this invention; and

FIG. 21 is a graph plotting the test data shown in FIG. 20.

### DESCRIPTION OF THE PREFERRED EMBODIMENTS

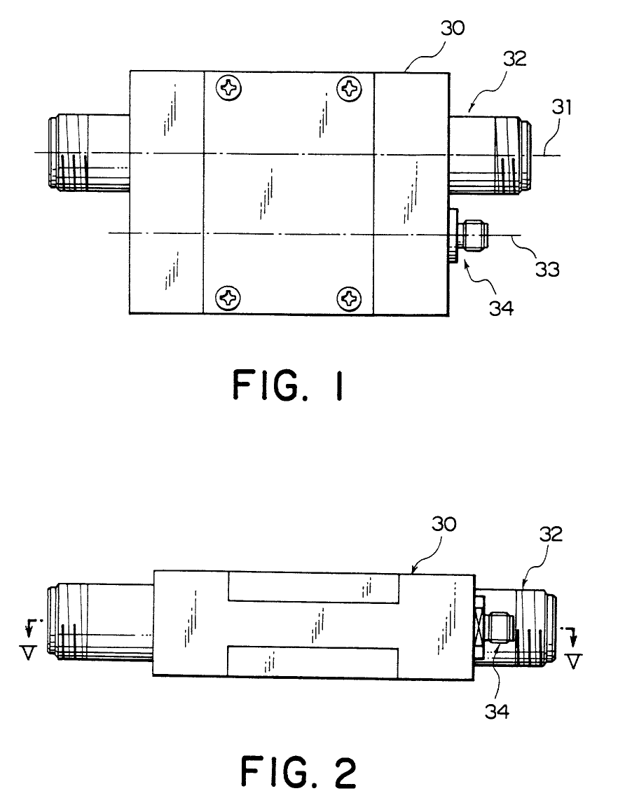

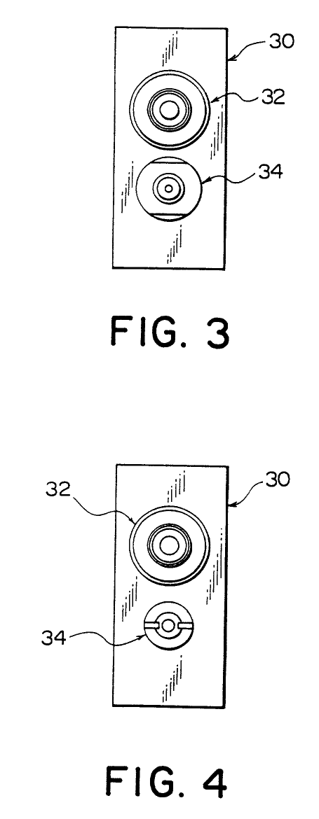

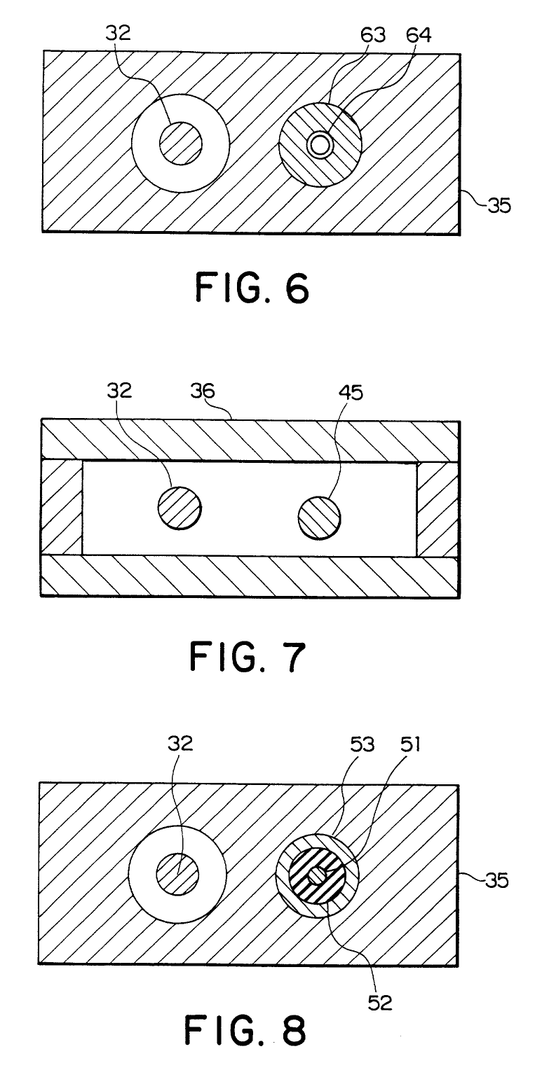

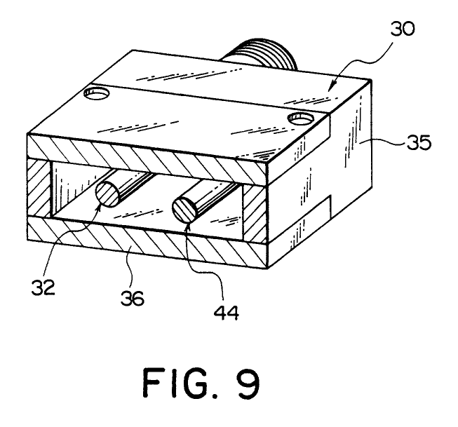

At first referring to FIGS. 1 to 9, description will be made of a directional coupler according to a first embodiment of this invention.

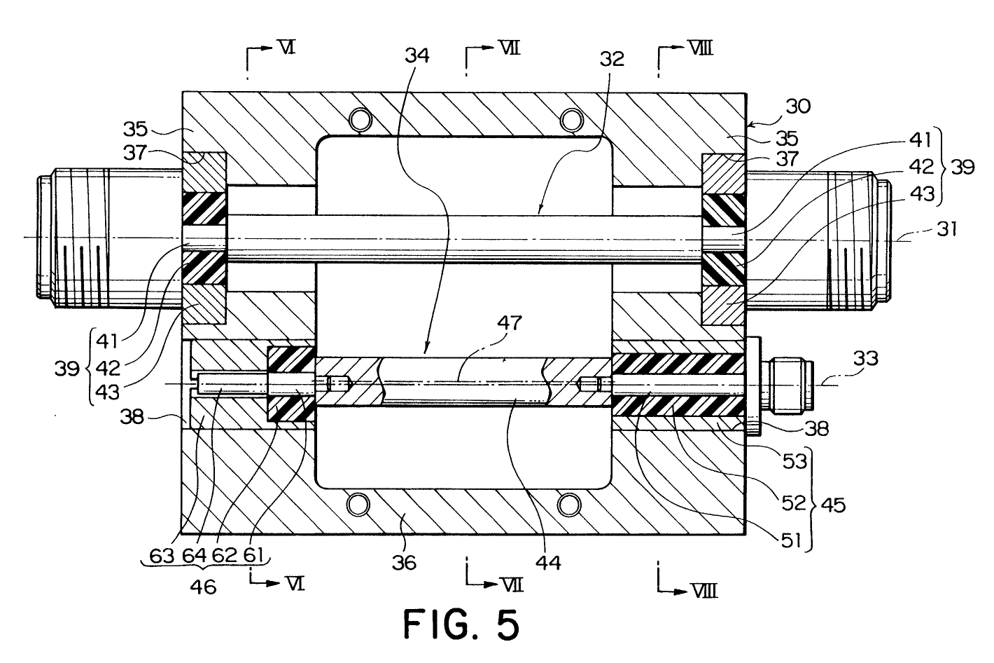

As best shown in FIG. 5, the directional coupler illustrated in the figures comprises a box-like conductive housing as a support member 30, a primary line 32 extending along a first axis 31 and supported by the support member 30, and a subsidiary line 34 extending along a second axis 33 and supported by the support member 30. The first and the second axes 31 and 33 extend in an axial direction to be parallel to each other with a space left therebetween.

The support member 30 comprises a pair of end walls 35 opposite to each other in the axial direction and a side wall 36 integrally formed with the end walls 35 and defining a cavity between the end walls 35. Each of the end walls 35 is provided with a primary hole or bore 37 and a subsidiary hole 38 formed at positions such that these holes of one and the other end walls 35 are faced to each other.

The primary line 32 has axial opposite ends to which a pair of connectors 39 as main ports are connected, respectively. Each of the connectors 39 comprises a center conductor 41 connected to the primary line 32 and an external conductor 43 surrounding the center conductor 41 through an insulator 42. The external conductor 43 is inserted to the primary hole 37 and fixed therein to be electrically connected to the support member 30. Thus, the center conductors 41 of the connectors 39 are electrically connected to each other through the primary line 32 while the external conductors 43 are electrically connected to each other through the support member 30. Each of the connectors 39 is connected to a transmission line (not shown).

The subsidiary line 34 has a conductive particular portion as an eccentric member 44 arranged substantially in parallel to the primary line 32 with a distance kept therefrom. The eccentric member 44 has both ends to which a pair of connectors 45 and 46 as subsidiary ports are fixedly coupled, respectively. These connectors 45 and 46 are rotatably supported by the end walls 35 of the support member 30, respectively. Thus, the subsidiary line 34 is rotatable around the second axis 33 with respect to the support member 30.

The eccentric member 44 extends along an eccentric axis 47 eccentric from respect to the second axis 33. The eccentric member 44 has a peripheral surface of a cylindrical shape around the eccentric axis 47 as a cylindrical axis. Therefore, the peripheral surface of the eccentric member 44 serves to vary the above-mentioned distance in response to the rotation of the subsidiary line 34. In this connection, the above-mentioned directional coupler is called an eccentric directional coupler.

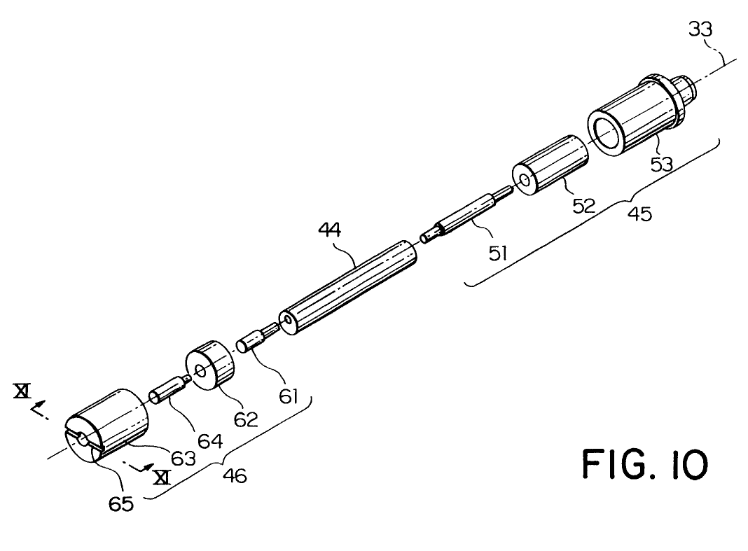

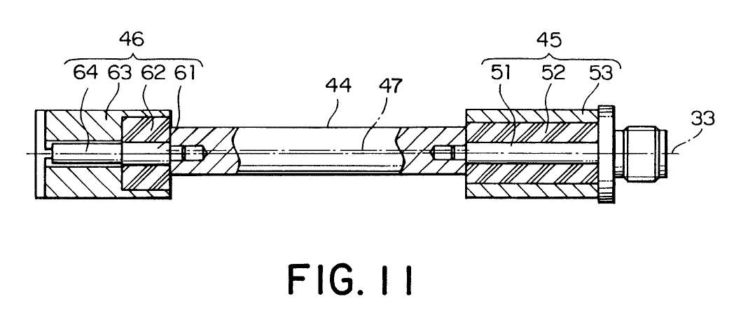

Referring to FIGS. 10 and 11 in addition, one connector 45 comprises a metal member 51 as a center conductor fixedly coupled to one end of the eccentric member 44, an insulator member 52 made of plastic or the like and fixedly holding the metal member 51, and a cylindrical member 53 as an external conductor made of metal and fixedly holding the insulator member 52. The eccentric member 44 and the metal member 51 are secured to each other by press-fitting. In order to secure the metal member 51 and the insulator member 52 to each other and to secure the insulator member 52 and the cylindrical member 53 to each other, press-fitting or adhesion is used. Instead of press-fitting or adhesion, these members may be engaged in the axial direction and a rotation direction by a combination of a projection and a recess formed on one and the other members, respectively.

The other connector 46 comprises a metal member 61 as a center conductor fixedly coupled to the other end of the eccentric member 44, an insulator member 62 made of plastic or the like and fixedly holding the metal member 61, a cylindrical member 63 as an external conductor made of metal and fixedly holding the insulator member 62, and an electronic component 64, such as an impedance-matching terminating resistor, connected to the metal member 61. The eccentric member 44 and the metal member 61 are secured to each other by press-fitting. In order to secure the metal member 61 and the insulator member 62 to each other and to secure the insulator member 62 and the cylindrical member 63 to each other, press-fitting or adhesion is used. Instead of press-fitting or adhesion, these members may be engaged in the axial direction and the rotation direction by a combination of a projection and a recess formed on one and the other members, respectively.

The cylindrical members 53 and 63 are rotatably inserted into the subsidiary holes 38 of the end walls 35 of the support member 30, respectively. In the subsidiary line 34 incorporated into the support member 30, the metal members 51 and 61 of the connectors 45 and 46 are electrically connected to each other through the eccentric member 44. Through the support member 30, the cylindrical members 53 and 63 of the connectors 45 and 46 are electrically connected to each other and to external conductors 43 of the connectors 39 connected to the primary line 32. Each of the connectors 45 and 46 is connected to a transmission line (not shown).

The cylindrical member 63 of the other connector 46 is provided with a groove 64 to receive a minus driver for driving the rotation. Therefore, the connector 46 can relatively easily be rotated.

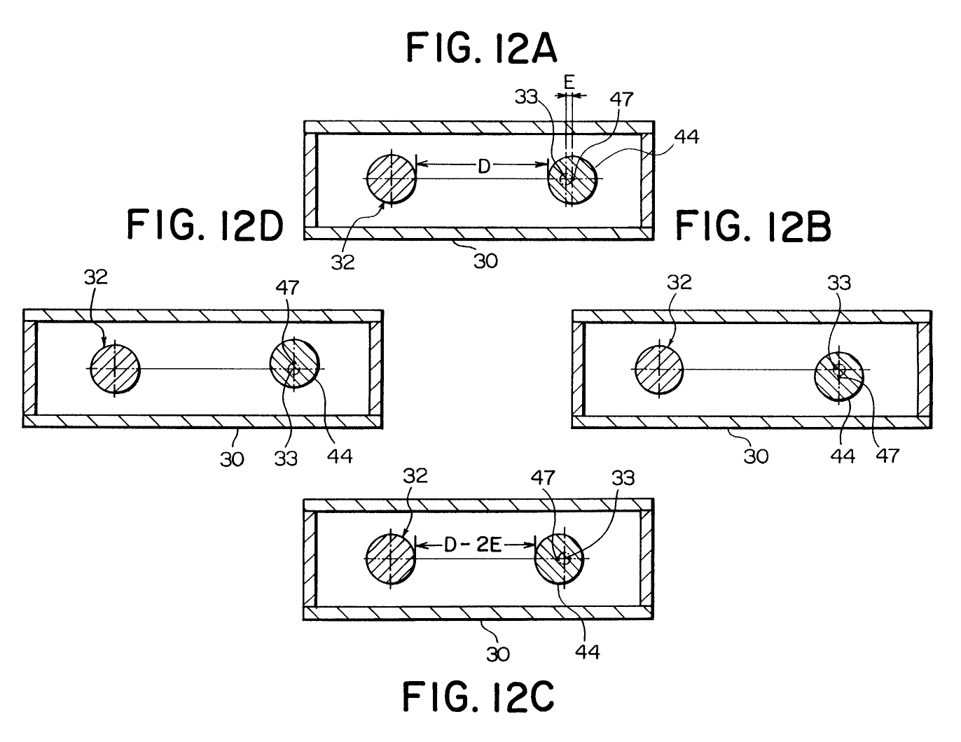

Referring to FIGS. 12A through 12D, description will be made of an operation of the directional coupler mentioned above. It is assumed here that the eccentric axis 47 is eccentric from the second axis 33 by an eccentric amount or distance E.

At first referring to FIG. 12A, the eccentric axis 47 is positioned on the side opposite to the first axis 31 with respect to the second axis 33. In this state, the peripheral surface of the eccentric member 44 is positioned at a greatest distance from the peripheral surface of the primary line 32. Let this greatest distance between the peripheral surfaces of the eccentric member 44 and the primary line 32 be represented by D. Referring to FIG. 12B, the eccentric member 44 is rotated by 90° in a clockwise direction with respect to the second axis 33. In this state, the distance between the peripheral surfaces of the eccentric member 44 and the primary line 32 is slightly reduced. Referring to FIG. 12C, the eccentric member 44 is further rotated by 90° in the clockwise direction with respect to the second axis 33. In this state, the distance is equal to (D−2E). Referring to FIG. 12D, the eccentric member 44 is further rotated by 90° in the clockwise direction with respect to the second axis 33. In this state, the distance is slightly extended. When the eccentric member 44 is further rotated by 90° in the clockwise direction with respect to the second axis 33, the state of FIG. 12A is recovered.

As described above, when the eccentric member 47 is rotated with respect to the second axis 33, the peripheral surface of the eccentric member 47 is located nearer to or farther from the peripheral surface of the primary line 32 so that the coupling factor is adjusted. Thus, by rotating the eccentric member 47, the coupling factor can finely be adjusted over a wide range.

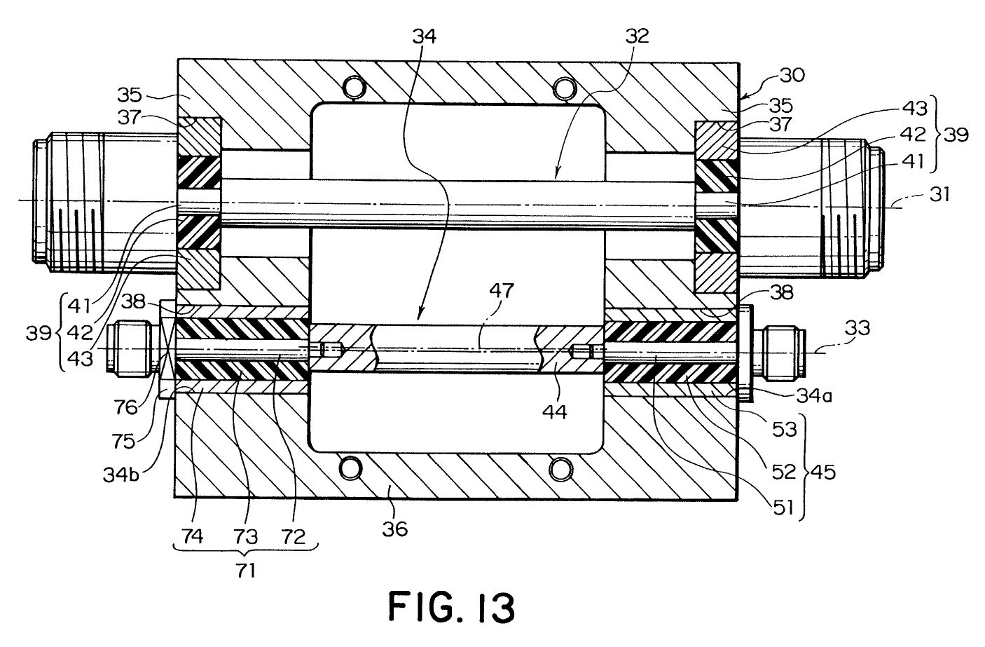

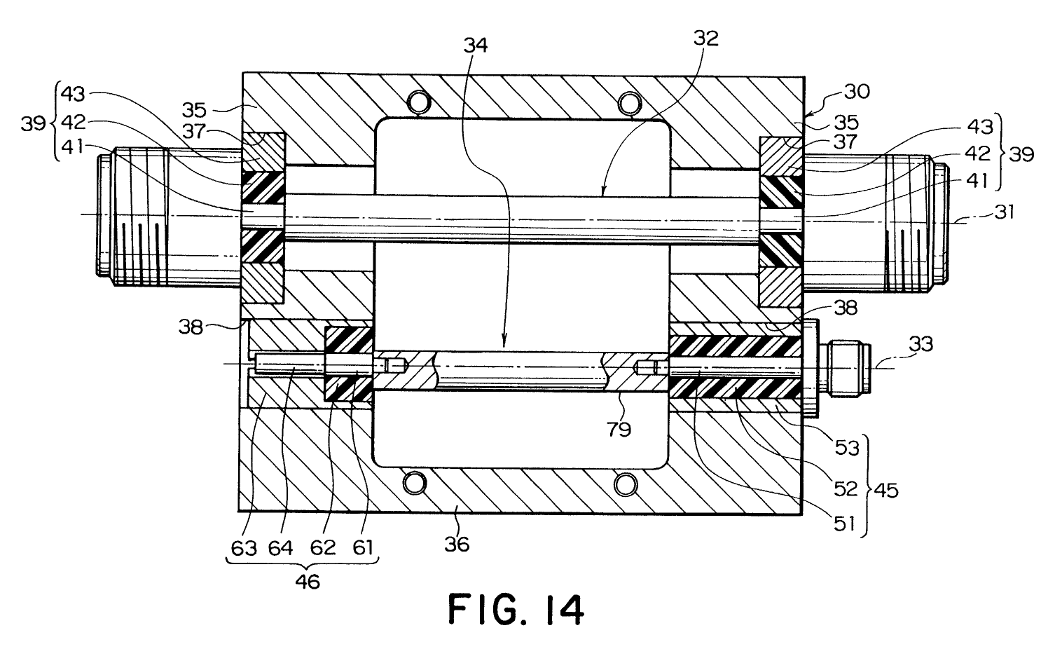

Referring to FIG. 13, description will be made of a modification of the above-mentioned directional coupler. Similar parts are designated by like reference numerals and will not be described any longer.

In the directional coupler illustrated in the figure, a connector 71 similar in structure to the one connector 45 is used as the other connector for the subsidiary line 34. Specifically, the connector 71 comprises a metal member 72 fixedly coupled to the eccentric member 44, an insulator member 73 made of plastic or the like and fixedly holding the metal member 72, and a cylindrical member 74 made of metal as an external conductor fixedly holding the insulator member 73 and rotatably supported by the support member 30.

The cylindrical member 74 has a flange portion 75 provided with a pair of flat portions 76 faced to each other in a radial direction. With this structure, the cylindrical member 74 can be easily rotated by clamping the flat portions 76 with a wrench or the like.

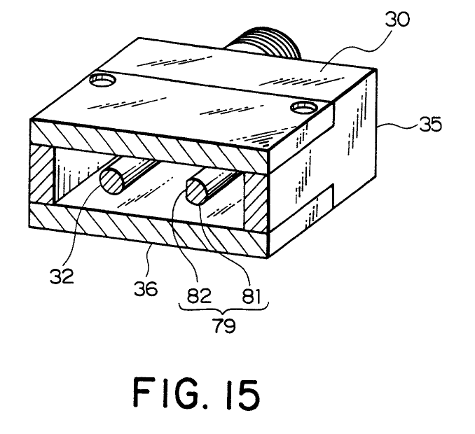

Next referring to FIGS. 14 and 15, description will be made of a directional coupler according to a second embodiment of this invention. Similar parts are designated by like reference numerals and will not be described any longer.

In the directional coupler illustrated in the figure, the subsidiary line 32 has a conductive deformed member 79 as a particular member arranged substantially in parallel to the primary line 32 with a distance kept therefrom. The deformed member 79 corresponds to the eccentric member 44 mentioned above and has opposite ends to which the connectors 45 and 46 are fixedly coupled, respectively.

The deformed member 79 extends along the second axis 33 with a shape kept constant throughout its entire length. The deformed member 79 has a peripheral surface of a non-cylindrical shape. Specifically, the peripheral surface of the deformed member 79 has a first portion 81 along a cylindrical shape and a second portion 81 of a flat shape adjacent to the first portion 81 in a circumferential direction. In other words, the deformed member 79 is formed by modifying or trimming a cylindrical member so that its cross section has a generally D shape. In this connection, the above-mentioned directional coupler is called a D-shaped directional coupler.

It will be understood that the cross section of the deformed member 79 may be a generally H shape or a polygonal shape such as a triangle or a rectangle.

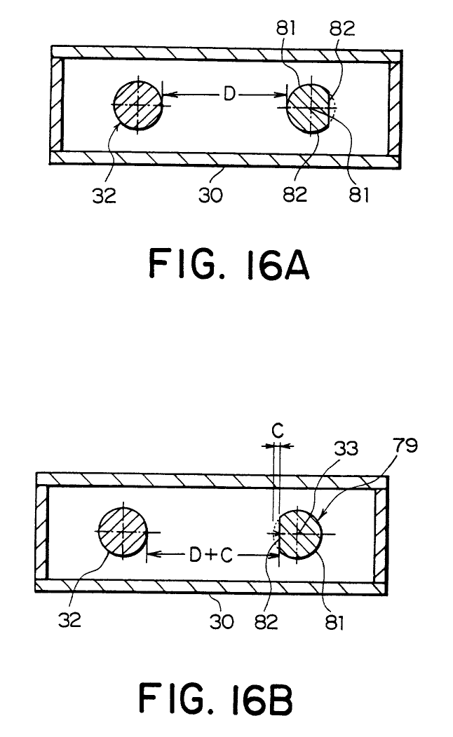

Referring to FIGS. 16A and 16B, description will be made of an operation of the directional coupler illustrated in FIGS. 14 and 15. It is assumed here that the trimmed amount of the deformed member 79 is represented by C.

At first referring to FIG. 16A, the second portion 82 is located on the side opposite to the first axis 31 with respect to the second axis 33. In this state, the peripheral surface of the deformed member 79 is located at a smallest distance from the peripheral surface of the primary line 32. The smallest distance between the peripheral surfaces of the deformed member 79 and the primary line 32 is represented by D. Referring to FIG. 16B, the deformed member 79 is rotated by 180° in the clockwise direction with respect to the second axis 33. In this state, the second portion 82 is faced to the primary line 32 and the distance between the peripheral surfaces of the deformed member 79 and the primary line 32 is equal to (D+C).

As described above, when the deformed member 79 is rotated with respect to the second axis 33, the peripheral surface of the deformed member 79 is positioned nearer to or farther from the peripheral surface of the primary line 32 so that the coupling factor is adjusted. Thus, by rotating the deformed member 79, the coupling factor can be adjusted.

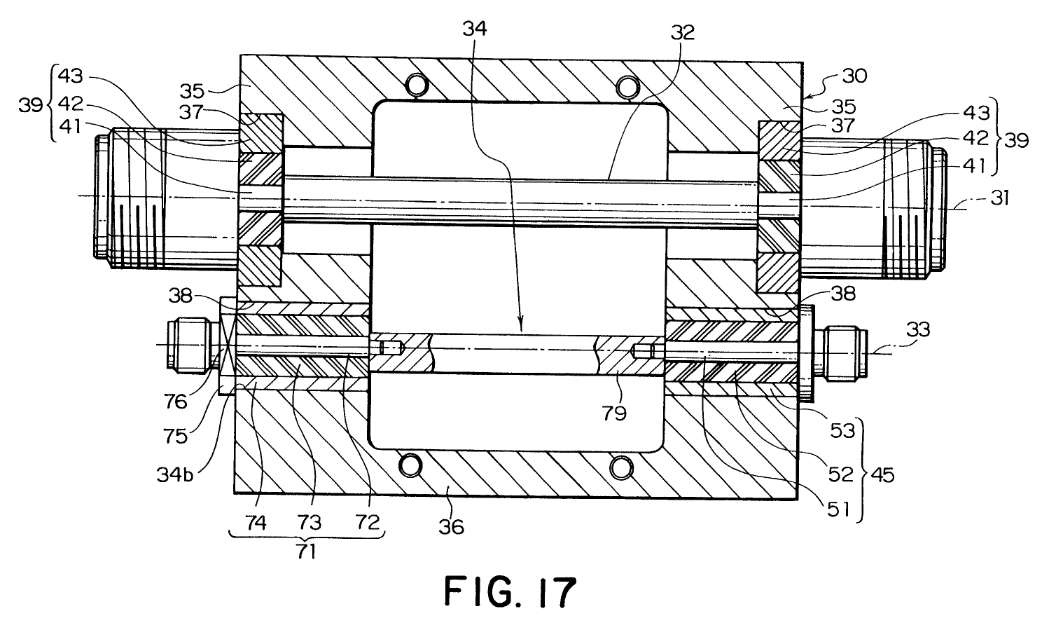

Referring to FIG. 17, description will be made of a modification of the directional coupler illustrated in FIGS. 14 and 15. Similar parts are designated by like reference numerals.

In the directional coupler illustrated in the figure, the connector 71 similar in structure to the one connector 45 is used as the other connector for the subsidiary line 34, like in the directional coupler illustrated in FIG. 13. The connector 71 is already described in conjunction with FIG. 13 and will no longer be described herein.

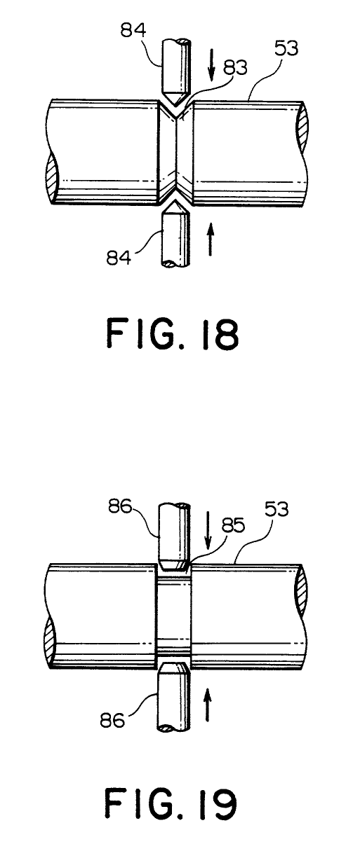

Referring to FIGS. 18 and 19 in addition to FIG. 5, description will be made of several examples of the structure of fixing the one connector 45 for the subsidiary line 34 to the support member 30.

Referring to FIGS. 5 and 18, the cylindrical member 53 of the connector 45 is provided with a ring-shaped V groove 83 formed on its outer peripheral surface. On the other hand, the support member 30 is provided with a pair of setscrews 84. The setscrews 83 are engaged with the V groove 83. With this structure, the connector 45 is engaged with the support member 30 in the axial direction but is rotatable with respect to the support member 30. After fine adjustment of the coupling factor, the setscrews 84 are tightened to fix the connector 45 to the support member 30.

Referring to FIG. 19, a U groove 85 and a pair of setscrews 86 may be used instead of the V groove 83 and the setscrews 84.

Although not described in detail, the other connector 46 or 71 is fixed to the support member 30 by the use of the similar structure.

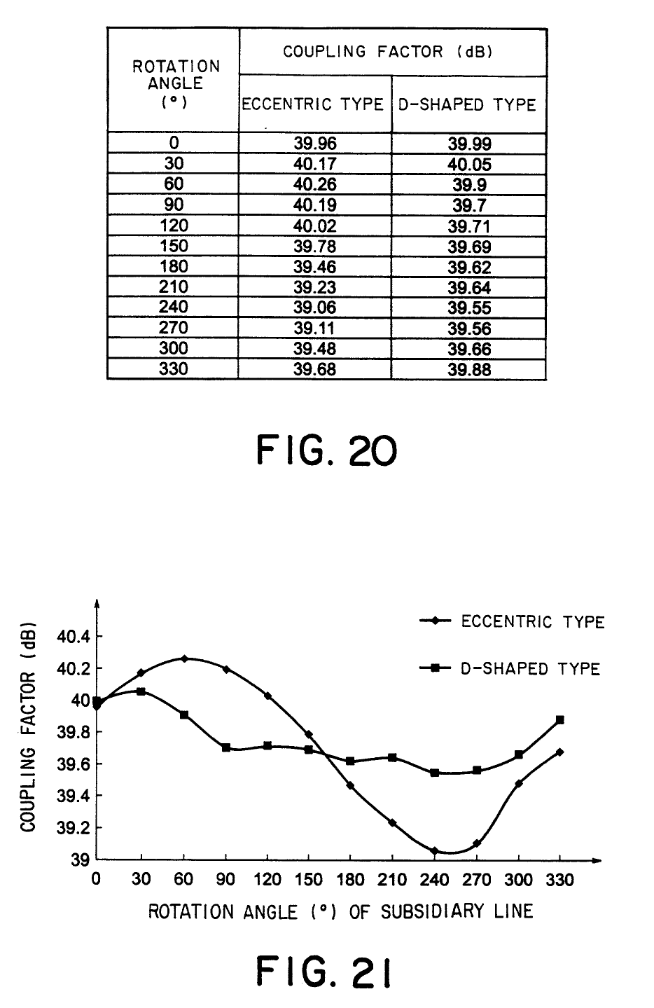

Referring to FIGS. 20 and 21, description will be made of a result of an evaluation test.

As seen from the figures, it has been found out that, in case of the eccentric directional coupler, the coupling factor varies substantially along a sinusoidal curve with respect to a rotation angle of the subsidiary line. Therefore, fine adjustment of the coupling factor can easily be carried out in the vicinity of a trough or a crest of the sinusoidal curve.

In case of the D-shaped directional coupler, the coupling factor also varies with respect to the rotation angle of the subsidiary line. Therefore, the fine adjustment of the coupling factor can similarly be carried out.

What is claimed is:

1. A directional coupler comprising:
a support member;
a primary line extending along a first axis and supported by said support member; and
a subsidiary line extending along a second axis and supported by said support member to be rotatable with respect to the second axis, said subsidiary line having a conductive particular portion arranged substantially in parallel to said primary line with a distance kept therefrom, said particular portion having a peripheral surface adapted to vary the distance in response to the rotation of said subsidiary line.

2. A directional coupler as claimed in claim 1, wherein said particular portion extends along an eccentric axis eccentric from said second axis.

3. A directional coupler as claimed in claim 2, wherein said peripheral surface of said particular portion has a cylindrical shape around said eccentric axis as a cylindrical axis.

4. A directional coupler as claimed in claim 1, wherein said peripheral surface of said particular portion has a non-cylindrical shape.

5. A directional coupler as claimed in claim 4, wherein said particular portion extends along said second axis.

6. A directional coupler as claimed in claim 4, wherein said peripheral surface of said particular portion has a first portion along a cylindrical shape and a second portion of a flat shape, said first and said second portions being adjacent to each other in a circumferential direction.

7. A directional coupler as claimed in claim 6, wherein said particular portion has a predetermined shape along said second axis.

8. A directional coupler as claimed in claim 4, wherein said particular portion has a cross section of a generally D shape.

9. A directional coupler as claimed in claim 1, further comprising a connector fixedly coupled to said particular portion and rotatably supported by said support member.

10. A directional coupler as claimed in claim 9, wherein said connector comprises:
a metal member fixedly coupled to said particular portion;
an insulator member fixedly holding said metal member; and
a cylindrical member fixedly holding said insulator member and rotatably supported by said support member.

11. A directional coupler as claimed in claim 10, wherein each of said support member and said cylindrical member has a conductivity.

12. A directional coupler as claimed in claim 1, wherein said subsidiary line has an electronic component electrically connected to said particular portion.

13. A directional coupler as claimed in claim 1, further comprising a structure of fixing said subsidiary line to said support member.
